(19) United States
(12) Patent Application Publication
(10) Pub. No.: US 2010/0318376 A1
(43) Pub. Date: Dec. 16, 2010

(54) MESSAGE-PASSING PROTOCOL BETWEEN ENTITIES HAVING DISSIMILAR CAPABILITIES

(75) Inventor: Michaeljon Miller, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/830,441

(22) Filed: Jul. 6, 2010

Related U.S. Application Data
(63) Continuation-in-part of application No. 12/483,248, filed on Jun. 12, 2009.
(60) Provisional application No. 61/356,039, filed on Jun. 18, 2010.

(51) Int. Cl. G06F 15/16; G06Q 50/00; G06Q 10/00

(52) U.S. Cl. 705/1.1; 709/204

(57) ABSTRACT

A system is described for conducting a communication exchange between at least a first entity and a second entity. In operation, the first entity and the second entity implement a communication mechanism that relies on a common set of method modules. Each method module may receive a message that conveys a particular action selected from a hierarchical collection of possible actions. By selecting a particular action, an entity which sends such a message may attempt to invoke a particular version of a message exchange between the entities. Through this provision, the communication exchange accommodates the situation in which different entities have different respective functionalities. According to one case, the system can be applied to the situation in which entities engage in a communication exchange to manage a resource.

This application claims the benefit of U.S. Provisional Application No. 61/356,039 (the '039 application), filed Jun. 18, 2010. This application is also a continuation-in-part of copending U.S. Ser. No. 12/483,248 (the '248 application), entitled, “Providing Resource-Related Information Using a Standardized Format,” filed on Jun. 12, 2009, and naming Michaeljon Miller as inventor. The '039 application and the '248 application are incorporated by reference herein in their respective entireties.

### BACKGROUND

Entities may interact with each other over the Internet to implement distributed applications. In such an environment, different entities perform different processing functions. The entities communicate with each other using an agreed-upon message-passing protocol.

For example, in one such approach, an entity can make use of remote functionality provided by a Web service by calling into a method offered by that Web service. More specifically, the entity generates a message in a form expected by the Web service, as specified by a Web Service Description Language (WSDL) description of the Web service. The message itself expresses information in the Extensible Markup Language (XML). The Web service then provides a response; that response is also formulated in the manner specified by the WSDL description of the Web service.

While popular, technologies for implementing distributed applications are not without their respective challenges. For instance, the Internet is a highly diverse and dynamic environment in which different entities can be expected to host different capabilities that suit their respective needs. One way to address this situation is to require that all participants to a conversation implement the exact same set of capabilities. This approach, however, may decrease the versatility and user-friendliness of the distributed application.

### SUMMARY

According to one illustrative implementation, a computer system is described herein for exchanging messages between at least a first entity and a second entity. The system includes a communication mechanism implemented by the first entity and the second entity. That is, the communication mechanism includes a first communication module implemented by the first entity and a second communication module implemented by the second entity. The first and second communication modules implement respective sets of method modules for performing respective communication tasks; the method modules used by the first communication module serve the same high-level conversational roles as same-named counterpart method modules used by the second communication module.

For example, according to one illustrative aspect, the common set of modules includes a start method module, a continue method module, a complete method module, and a query method module. Each method module is configured to receive an invoking message that specifies a particular action to be taken. That particular action is selected from a hierarchical collection of possible actions for that particular method module. For example, a start message (which is sent to the start method module) specifies a particular request action. That request action is selected from a hierarchical collection of possible request actions, associated with a general request base class.

The above-summarized approach provides a common communication mechanism (by virtue of the use of four common method modules), yet still enables the first entity and the second entity to host different respective functionalities. For example, the first entity may send a start message to the second entity to request the second entity to invoke a particular request action. The second entity, upon receiving the start message, may send a continue message to the first entity. The continue message may specify a particular continuation action that reflects a particular version of a communication exchange which the second entity wishes to invoke. In this manner, different entities, at different stages in the conversation, may attempt to dictate the version of the communication exchange that is to be performed.

According to another illustrative aspect, the above-summarized computer system is used to conduct a message exchange pertaining to the management of a resource, such as an energy resource. For instance, the first entity may correspond to a resource management facilitator (“facilitator”) and the second entity may correspond to a utility entity. In one environment, the facilitator can collect resource information from the utility entity for dissemination to at least one authorized end user. By virtue of the provisions summarized above, different utility entities may have different respective functionalities. Therefore, in the course of conversations, different utility entities may seek to invoke different respective communication exchanges. The facilitator can accommodate such flexibility without forcing each utility entity to behave in the same manner. A utility entity can convey its communication preferences during the course of the conversation.

The above functionality can be manifested in various types of systems, components, methods, computer readable media, schemas, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a computer system (“system”) for implementing a message exchange between at least a first entity and a second entity, which accommodates the use of different functionalities provided by the entities.

FIG. 2 shows first and second communication modules respectively implemented by the first and second entities of FIG. 1, together forming a communication mechanism.

FIG. 3 shows an illustrative message-sending protocol between the first entity and the second entity of FIG. 1.

FIGS. 4 and 5 show two respective namespace hierarchies, identifying different types of request actions and continuation actions that can be specified by the message exchange of FIG. 3.

FIG. 6 is a flowchart that describes operations performed by the first entity and the second entity of FIG. 1, to carry out the message exchange of FIG. 3.

FIG. 7 shows a workflow management module implemented by each of the first entity and the second entity of FIG. 1.

FIG. 8 shows one illustrative implementation of the system of FIG. 1 in which entities conduct a message exchange that pertains to the management of a resource.

FIG. 9 shows additional illustrative details of the implementation of FIG. 8.

FIGS. 10 and 11 show an illustrative message exchange between two entities shown in FIG. 8 according to two respective conversation flow options.

FIG. 12 shows illustrative processing functionality that can be used to implement any aspect of the features shown in the foregoing drawings.

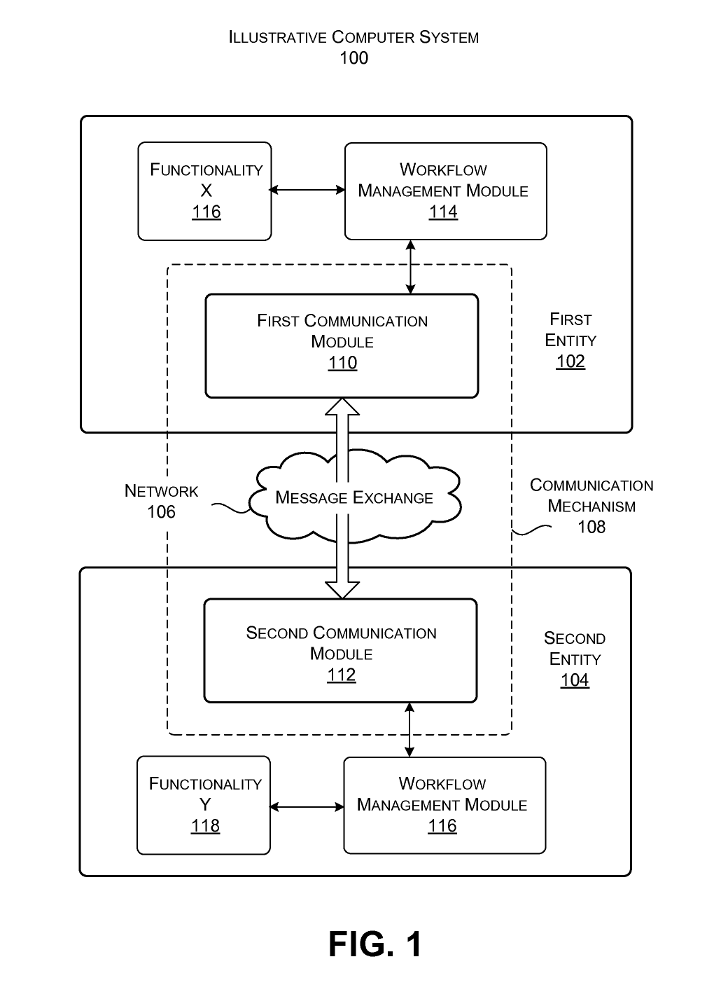

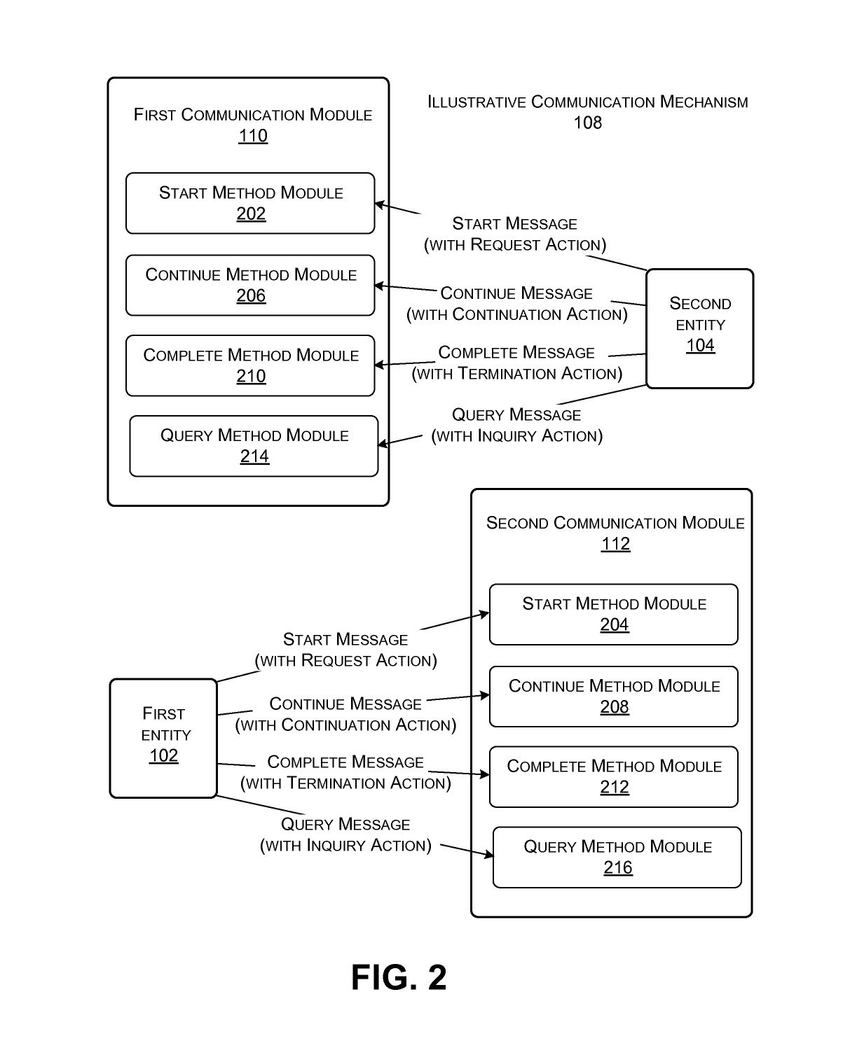

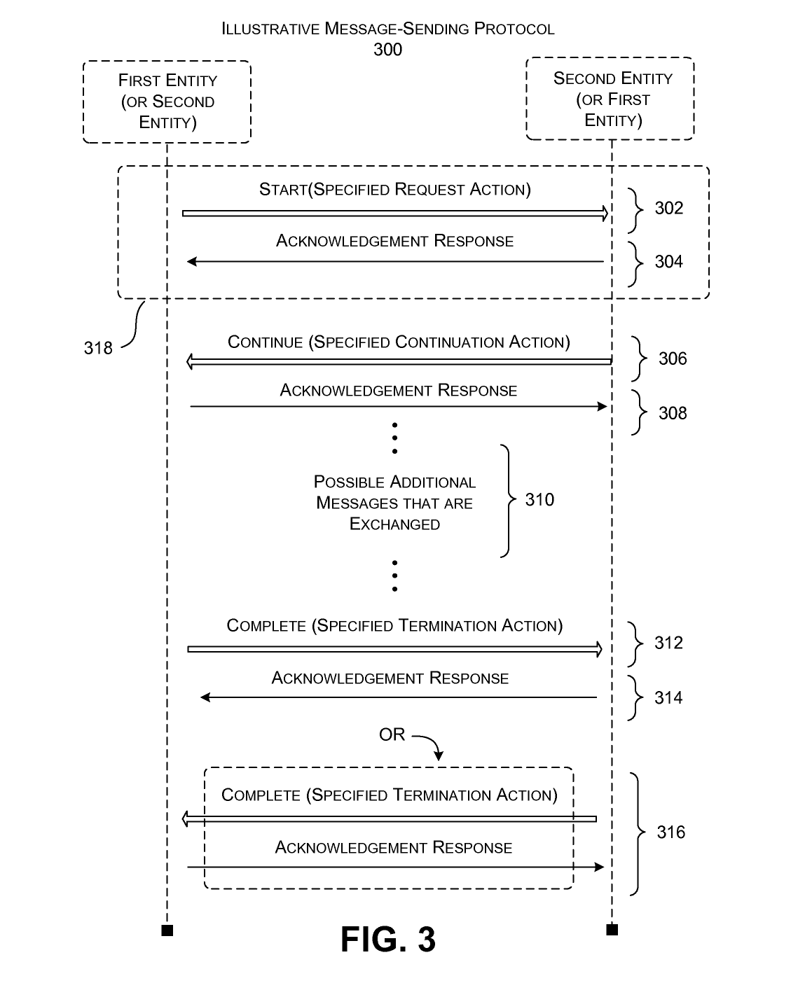

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth a message-passing protocol among entities that potentially may have dissimilar capabilities. The disclosure is organized as follows. Section A presents a general overview of a computer system that implements a communication exchange between at least a first entity and a second entity. Section B describes one implementation of the computer system of Section A; in this example, various entities cooperate to manage a resource. Section C describes illustrative processing functionality that can be used to implement any aspect of the features described in the preceding sections.

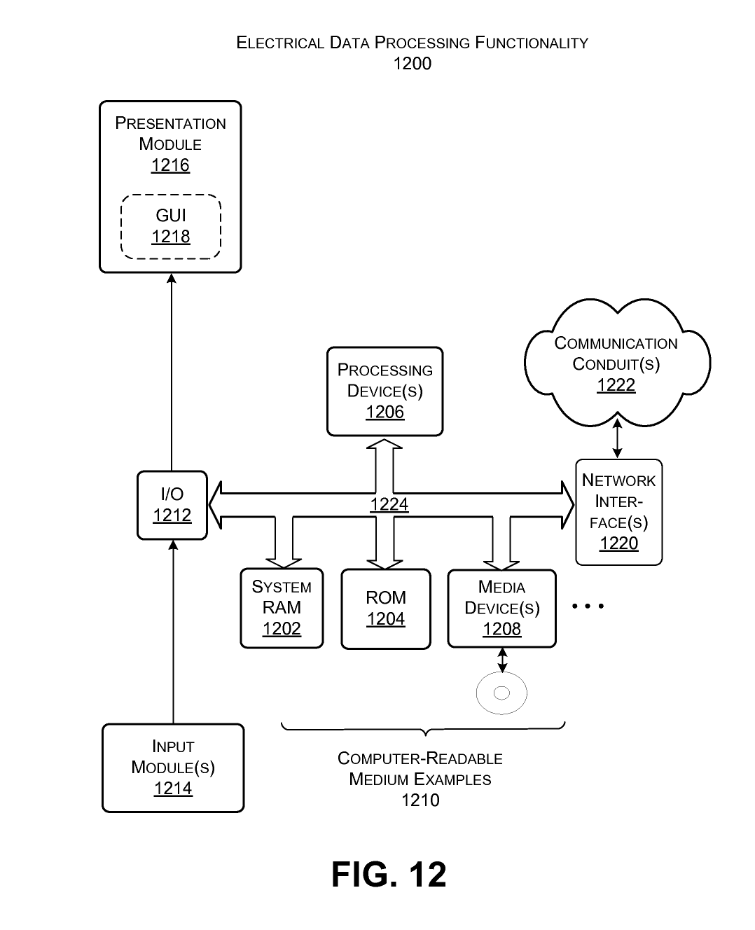

As a preliminary matter, some of the figures describe concepts in the context of one or more structural components, variously referred to as functionality, modules, features, elements, entities, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 12, to be discussed in turn, provides additional details regarding one illustrative implementation of the functions shown in the figures.

Other figures describe the concepts in flowchart or message exchange form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

As to terminology, the phrase “configured to” encompasses any way that any kind of functionality can be constructed to perform an identified operation. The terms “logic” or “logic component” encompass any functionality for performing a task. For instance, each operation illustrated in the flowcharts corresponds to a logic component for performing that operation. When implemented by a computing system, a logic component represents a physical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Overview

FIG. 1 shows an illustrative computer system (“system”) 100 for conducting a message exchange between a first entity 102 and a second entity 104. The first entity 102 and the second entity 104 can each correspond to any type of processing functionality, e.g., each composed of one or more computer devices of any type(s), one or more data stores, and/or other processing equipment. FIG. 1 shows that the system 100 includes only the first entity 102 and the second entity 104; however, the system 100 can accommodate communication among any number of entities.

The first entity 102 and the second entity 104 communicate with each other via a network 106. The network 106 can be implemented as a wide area network (such as the Internet), a local area network, a point-to-point connection, or some combination thereof. The network 106 can include any combination of hardwired links, wireless links, routers, gateways, name servers, and so on. The network 106 can be governed by any protocol or combination of protocols.

The first entity 102 and the second entity 104 communicate with each other to implement distributed processing functionality. That is, the message exchange allows the first entity 102 to make use of processing functions provided by the second entity 104; it further allows the second entity 104 to make use of processing functions provided by the first entity 102. Section B sets forth one illustrative implementation of the system 100. In that case, the first entity 102 and the second entity 104 communicate with each other for the purpose of managing a resource.

A communication mechanism 108 enables the first entity 102 and the second entity 104 to communicate with each other. In one implementation, the communication mechanism 108 includes a first communication module 110 implemented by the first entity 102 and a second communication module 112 implemented by the second entity 104.

As will be described below (with reference to FIG. 2), the first communication module 110 and the second communication module 112 implement a common set of method modules. That is, the first communication module 110 provides an interface which exposes a first set of method modules to the second entity 104. The second entity 104 may send messages which invoke the method modules of the first entity 102. Similarly, the second communication module 112 provides an interface which exposes a second set of method modules to the first entity 102. The first entity 102 may send messages which invoke the method modules of the second entity 104. The method modules are said to be common in the sense that the first set of method modules exposes the same interfaces as the second set of method modules. That is, the method modules used by the first communication module 110 serve the same high-level conversational roles as same-named counterpart method modules used by the second communication module 112. In one implementation, common method modules exhibit the same general behavior and are structured in the same manner.

Without limitation, in one implementation, the system 100 implements the communication mechanism 108 using Web service technology. In this technology, entities access Web services provided by other entities by sending Simple Object Access Protocol (SOAP) messages to the other entities. SOAP messages, in turn, use the Extensible markup Language (XML) format to express information. Web Service technology is described in a number of sources, such as the introductory document entitled “Web Service Architecture,” provided by W3C Working Group, Feb. 11, 2004. In other implementations, the system 100 can rely on other distributed processing protocols, such as Distributed Component Object Model (DCOM), Common Object Request Broker Architecture (CORBA), Java Remote Method Invocation (RMI), etc.

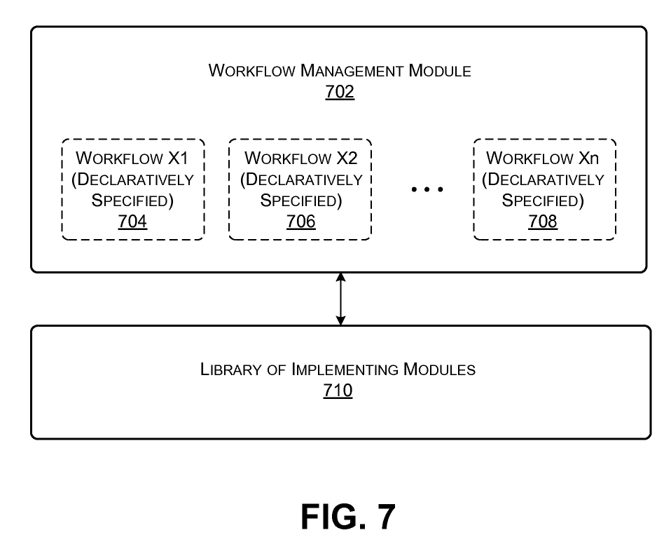

The first entity 102 includes a workflow management module 114. The workflow management module 114 manages tasks to be performed by the first entity 102 in the course of a conversation with the second entity 104. More specifically, the workflow management module 114 can create a workflow for each conversation that has been requested by a conversation-invoking entity (e.g., either the first entity 102 or the second entity 104). The workflow management module 114 can update these workflows throughout the course of the conversations. The second entity 104 includes another workflow management module 116 which manages tasks to be performed by the second entity 104 in a similar manner. Additional details regarding the workflow management modules (114, 116) are presented in the explanation of FIG. 7 (below).

The tasks performed by the first entity 102 may involve the use of functionality 118 provided by (or otherwise accessible to) the first entity 102. For example, the functionality 118 may comprise application modules that perform respective functions within an application-specific environment. Similarly, the tasks performed by the second entity 104 may involve the use of functionality 120 provided by (other otherwise accessible to) the second entity 104.

The functionality 118 provided by the first entity 102 defines the processing capabilities of the first entity 102, while the functionality 120 provided by the second entity 104 defines the processing capabilities of the second entity 104. In one case, the capabilities of the first entity 102 may be the same as the capabilities of the second entity 104; in other cases, the capabilities may differ. To clearly demarcate concepts, FIG. 1 depicts the functionality 118 as being distinct from the first communication module 110, and depicts the functionality 120 as being distinct from the second communication module 112. However, at least part of the functionality 118 can be implemented by the first communication module 110, and at least part of the functionality 120 can be implemented by the second communication module 112.

The following explanation will set forth the manner in which the communication mechanism 108 handles communication between the first entity 102 and the second entity 104, even though these entities may have different capabilities. By way of broad overview, the first communication module 110 and the second communication module 112 can exchange messages using the above-described common method modules. Each message also identifies a particular action to be performed. And each particular action, in turn, is selected from at least one set of possible actions described in at least one hierarchal namespace of actions.

By specifying a particular action, a sending entity (meaning an entity which sends a message) can notify a receiving entity (meaning an entity that receives the message) of its intent to invoke a particular version of a message exchange. In this manner, the sending entity can attempt to dictate a message exchange which accommodates its capabilities. As will be explained below, over the course of a particular message exchange, either (or both) the first entity 102 or the second entity 104 can attempt to influence the course of a communication exchange at different junctures of the communication exchange.

FIG. 2 shows the illustrative composition of the first communication module 110 implemented by the first entity 102 and the second communication module 112 implemented by the second entity 104. As described above, the communication modules (110, 112) implement a common set of method modules. The first entity 102 can call the method modules of the second communication module 112 to invoke functionality provided by the second entity 104, and the second entity 104 can call the method modules of the first communication module 110 to invoke functionality provided by the first entity 102.

In one implementation, the common method modules correspond to at least four method interfaces. A first method module corresponds to a start method module. Namely, the first communication module 110 implements a start method module 202 and the second communication module 112 implements a start method module 204. The first entity 102 can call the start method module 204 of the second entity 104 (and vice versa). The message received by a start method module is referred to herein as a start message. The start message specifies a particular request action to be performed.

A second method module corresponds to a continue method module. Namely, the first communication module 110 implements a continue method module 206 and the second communication module 112 implements a continue method module 208. The second entity 104 can call the continue method module 206 (and vice versa) of the first entity 102 in response to receiving a request message from the first entity. The message received by a continue method module is referred to as a continue message. The continue message specifies a particular continuation action to be performed.

More specifically, assume that the second entity 104 receives a start message from the first entity 102. The start message instructs the second entity 104 to perform a particular request action. In response, the second entity 104 may call the continue method module 206 of the first entity 102, conveying a continue message that specifies a particular continuation action. That continuation action notifies the first entity 102 of a particular version of message exchange that the second entity 104 seeks to invoke, and thereby implicitly notifies the first entity 102 of the capabilities of the second entity 104.

A third method module corresponds to a complete method module. Namely, the first communication module 110 implements a complete method module 210 and the second communication module 112 implements a complete method module 212. The first entity 102 can call the complete method module 212 of the second entity 104 (and vice versa). The message received by a complete method module is referred to as a complete message. The complete message specifies a particular termination action to be performed.

A fourth method module corresponds to a query method module. Namely, the first communication module 110 implements a query method module 214 and the second communication module 112 implements a query method module 216. The first entity 102 can call the query method module 216 of the second entity 104 (and vice versa) to determine any aspect of an ongoing conversation. For example, the first entity 102 can call the query method module 216 of the second entity 104 to determine the current state of the conversation (as assessed from the perspective of the second entity 104). Alternatively, or in addition, the first entity 102 can call the query method module 216 of the second entity 104 to determine information regarding future and/or previous operations associated with the conversation; for example, the first entity 102 can use this approach to determine what actions it may next be asked to perform. The message received by a query method module is referred to as a query message. The query message specifies a particular inquiry action to be performed.

The above-described four method modules are illustrative. Other implementations can include fewer than four method modules or more than four method modules; in addition, or alternatively, other implementations can include other method modules that have different behaviors compared to the interfaces described above. In any case, in one implementation, a Web Services Description Language (WSDL) description can be formulated which defines the characteristics of the method modules set forth above.

Further, in one case, each entity can implement the four method modules as four distinct interfaces that other entities can access. In another case, an entity can implement any two or more of the method modules using a single interface. For example, the continue method module and the complete method module can be implemented by a single update method module. The update method module can receive an update message that identifies a particular status updating action. The update method module functions as both the continue method module and the complete method module; that is, its behavior depends on the context in which it is called and the actions specified by the update messages it receives. However, to facilitate explanation, the following description will consider the four method modules depicted in FIG. 2 as distinct interfaces.

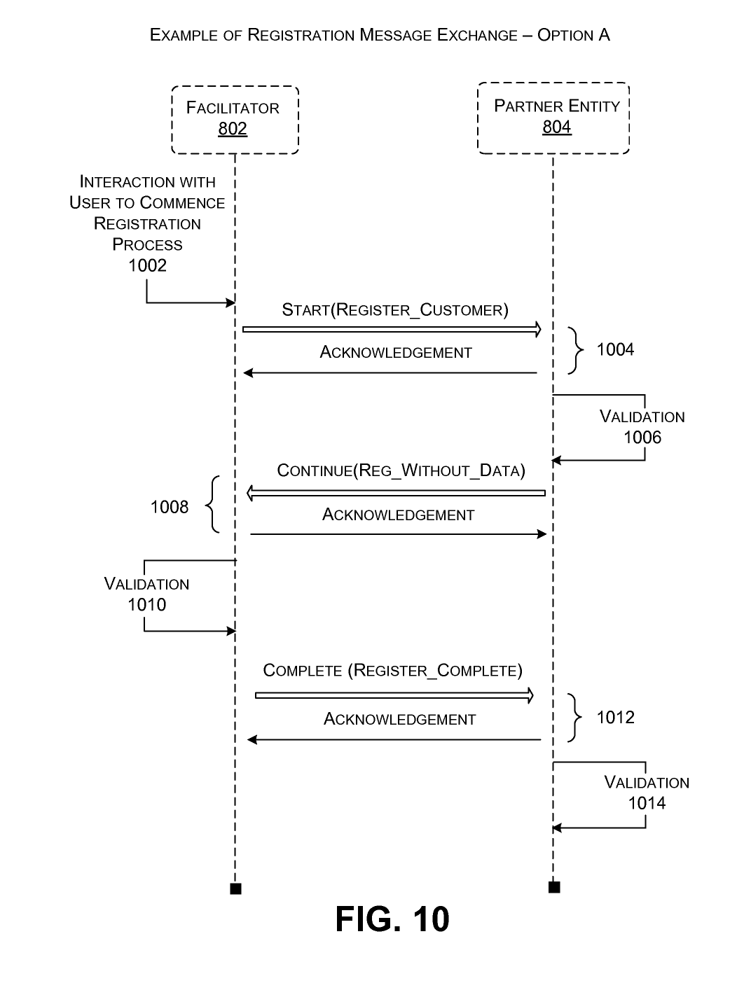

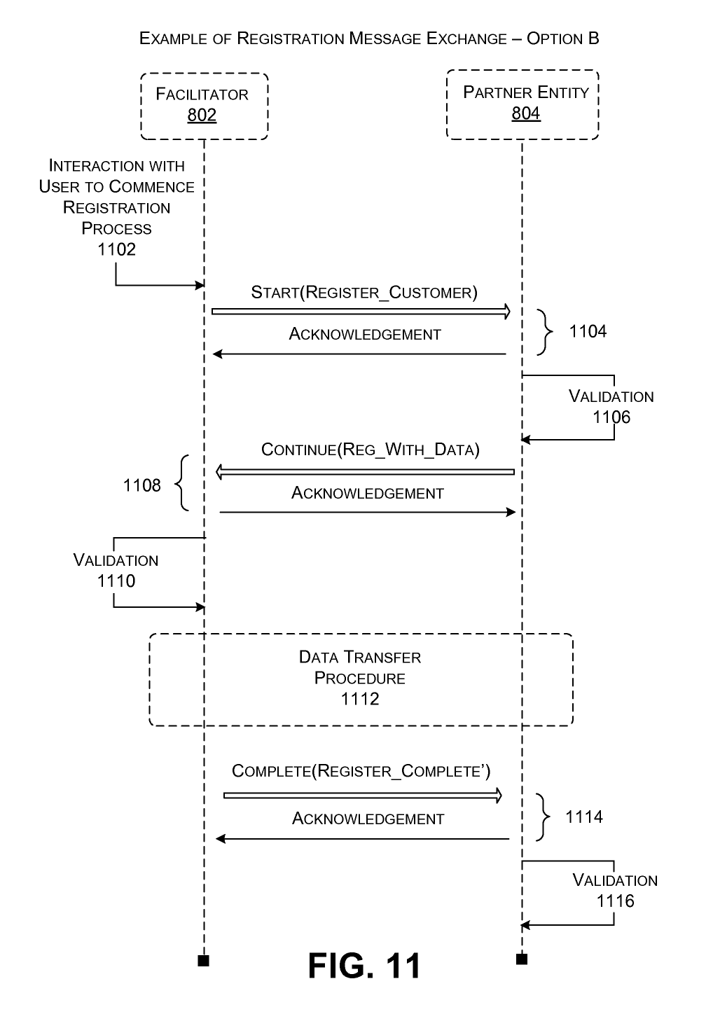

FIG. 3 shows an overview of one message-sending protocol 300 that can be conducted between the first entity 102 and the second entity 104. In this description, it will be assumed that the first entity 102 initiates the conversation, but the roles of the first entity 102 and the second entity 104 can be reversed. FIGS. 10 and 11 (to be described below in Section B) apply the general principles set forth in FIG. 3 to a particular application environment.

In operation 302, the first entity 102 sends a start message which invokes the start method module 204 of the second entity 104. The start message specifies a particular request action. In operation 304, the second entity 104 optionally sends an acknowledgment message to the first entity 102, which acknowledges receipt of the start message.

In operation 306, the second entity 104 sends a continuation message which invokes the continue method module 206 of the first entity 102. The continuation message specifies a particular continuation action, which, in turn, dictates the course of the subsequent message exchange. In other words, the second entity 104 uses the continue message to inform the first entity 102 that it has particular capabilities. In operation 308, the first entity 102 optionally sends an acknowledgement message to the second entity 104, which acknowledges receipt of the continue message.

Operations 310 indicates that the first entity 102 and the second entity 104 may exchange any number of messages of any type, in accordance with the environment-specific nature of a particular conversion taking place. For example, the first entity 102 and/or the second entity 104 may send one or more continue messages to attempt to dictate the course of the subsequent conversation. Further, although not shown, any entity, at any juncture, may send a query message to its counterpart entity.

In operation 312, at the end of the conversation, the first entity 102 may send a complete message to the second entity 104, which invokes the complete method module 212 of the second entity 104. The complete message specifies a particular termination action. In operation 314, the second entity 104 optionally sends an acknowledgment message to the first entity 102, which acknowledges receipt of the complete message. Operations 316 indicate that, instead of operations 312 and 314, the second entity 104 may send a complete message to the first entity 102.

In the above explanation, the particular request action conveyed by a start message is selected from a hierarchical namespace (or other organization) of possible request actions. The particular continuation action conveyed by a continue message is selected from a hierarchical namespace (or other organization) of possible continuation actions. The particular termination action conveyed by a complete message is selected from a hierarchical namespace (or other organization) of possible termination actions. And the particular query action conveyed by a query message is selected from a hierarchical namespace (or other organization) of possible query actions (although, in other implementations, the query-related namespace identifies a single query action).

In the above explanation, the first entity 102 sends a single start message to the second entity 104 to initiate a conversation with the second entity 104. That start message attempts to invoke a particular version of a conversation that is associated with a specified request action. Although not shown, the second entity 104 may be unable to take part in the requested version of the conversation, e.g., because it does not have the requisite functionality. In this case, the second entity 104 can convey its non-acceptance of the request action to the first entity 104. In one scenario, the request-declining response of the second entity 104 may effectively terminate the conversation. In another scenario, the first entity 102 can respond to the non-acceptance by sending another start message to the second entity 104. This subsequent start message may specify a request action that corresponds to another version of the conversation; in one scenario, for example, this other version may represent a more rudimentary version of the conversation compared to that specified by the previously-sent start message. The second entity 104 can respond to the subsequent start message by accepting it in the manner specified above (e.g., by sending a continue message), or by again declining it. In yet another implementation, the second entity 104 can further act on any declined start message by sending its own start message to the first entity 102; in other words, the second entity 104 can potentially take over as the initiator of the conversation.

The above exchange of messages may be regarded as a version negotiation procedure by which the communication participants agree on a version of a conversation. FIG. 3 represents this version negotiation as dashed-lined box 318. As mentioned, although not shown, the version negotiation can involve sending any number of start messages from the first entity 102 to the second entity 104 and/or from the second entity 104 to the first entity 102. Further, although not shown, the communication participants can perform a version negotiation at any stage of the conversation. For example, assume that the first entity 102 does not “understand” the continue message that the second entity 104 sends to it. In response, the second entity 104 can send another continue message to the first entity 102 which specifies another variation of the basic continuation action which the second entity 104 seeks to invoke.

In yet another variation, a callee entity may, instead of returning a failure indication, return an indication of an acceptable message version (from the perspective of the callee entity). For example, assume the caller entity wants to start a conversation by sending message X″, which corresponds to version 2 of a particular request action. But assume that the callee entity has functionality for only handling version 1 of the particular request action, which corresponds to a message X′. The callee entity can respond to message X″ by returning a response that indicates that it is capable of responding to version 1 of the request action, but not version 2. For instance, the callee entity can return a response that conveys the fully-qualified name of the supported message (X′). In this manner, the caller entity does not need to repeatedly guess at a message type that may be supported by the callee entity.

The callee entity can determine the supported counterpart (message X′) corresponding to the non-supported original message (X″) in different ways. In one case, the participants of a communication exchange can receive information (e.g., metadata) regarding different types of invoking messages that can be used to perform a particular type of action. For example, assume that there are three ways to charge an electric vehicle and that there are three corresponding messages that invoke these actions. The communication participants can receive information regarding these messages, even though some communication participants may not be able to handle some of these messages. If a callee entity then receives a message that it cannot act on, it may consult the master list of message names to determine a counterpart message in the same family of actions that it can respond to (if any). The callee entity then conveys this acceptable message name to the caller entity.

In this mode of version negotiation, the communication participants can receive information regarding the master list of invoking messages in different ways. For example, a communication participant which creates (or otherwise learns of) a new message type can send metadata regarding a current master list of possible messages to the other communication participants. Alternatively, or in addition, entities that initiate a conversation can, at some point in the conversation, exchange metadata in any manner so that the participants are all aware of the current master list of messages. In one implementation, the master list of messages can be structured as a hierarchy of actions, to be described in greater detail below.

In other circumstances, the callee entity may receive a message that pertains to a general action that can be performed in different ways. For example, the callee entity may receive a message that contains a general instruction to charge an electric vehicle. If the callee entity can carry out this action in at least one manner, then version negotiation is not performed. Rather, the callee entity may send a continue message in the manner described above to “steer” the conversation along a particular action path, e.g., by telling the caller entity how it plans to charge the vehicle.

In general, the message-sending protocol 300 of FIG. 3 is independent of time in the sense that the timing at which messages are sent can be spread out over any span of time in an arbitrary manner, based on the particular nature of each conversation. In other words, the message-sending protocol 300 is asynchronous. Further, the message-sending protocol 300 is independent of location in the sense that any entity at any location can implement the endpoints specified in the WSDL description. Further, the message-sending protocol 300 is independent of version in the sense that any entity can adopt any version, so long as that version conforms to actions specified in accepted hierarchies of actions.

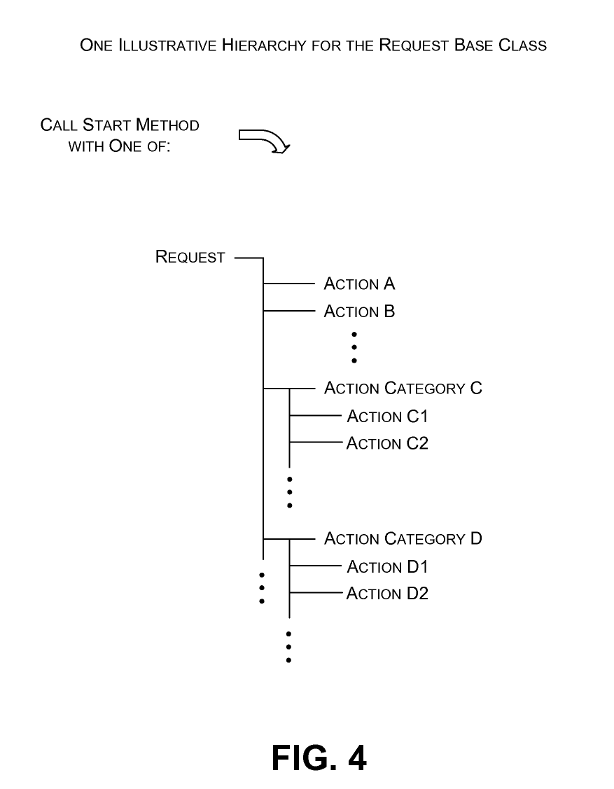

FIG. 4 shows one example of a possible namespace associated with a set of possible request actions. At the highest level, the start method module is associated with a generic request action. Other request actions identified in the hierarchy depend (or derive) from the general request action. The generic request action is associated with a base request class. The other (subordinate) request actions correspond to classes that depend (or derive) from the base request class. Accordingly, each child class inherits characteristics of its parent class and ancestor class(es) (if any). For example, each child class inherits metadata associated with its parent class and ancestor class(es) (if any). An entity can instantiate any class identified in the hierarchy to yield functionality for actually carrying out the corresponding request action.

In the merely representative case of FIG. 4, actions A and B can correspond to two request actions that any entity can invoke. Action category C may correspond to a collection of request actions that are associated with a particular type of entity, and action category D may correspond to a collection of request actions that are associated with another type of entity. A type-C entity may seek to invoke one of the request actions in the category C actions, while a type-D entity may seek to invoke one of the request actions in the category D actions, and so on. To emphasize, however, the hierarchical organization of request actions shown in FIG. 4 is merely representative. Other organizations can define other arrangements of request actions. For example, in another organization, the category C actions may correspond to different versions in a same family of actions, and the category D actions may correspond to different versions in another family of actions. For example, the category C actions may correspond to different ways of charging an electric vehicle. Although not shown, the different actions in a family of actions can have a nested relationship. For example, in the case in which action C2 is a later-implemented variation of action C1, then C2 can be nested under C1. In one implementation of version negotiation described above, a callee entity can “walk” the hierarchy to determine an action in a basic family of actions that it can support; for example, if it cannot support action C2, it may determine whether it can support action C1.

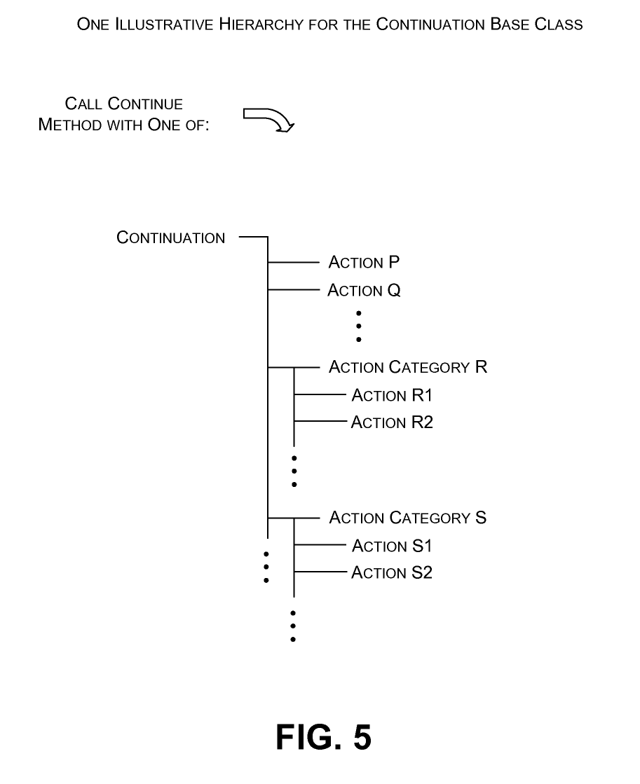

FIG. 5 shows one example of a possible namespace associated with continuation actions. At the highest level, the continue method module is associated with a generic continuation action. Other continuation actions identified in the hierarchy depend (or derive) from the general continuation action. The generic continuation action is associated with a base continuation class. The other (subordinate) continuation actions correspond to classes that depend (or derive) from the base continuation class. An entity can instantiate any class identified in the hierarchy to yield functionality for actually carrying out the corresponding continuation action.

In the merely representative case of FIG. 5, request actions P and Q can correspond to two continuation actions that any entity can invoke. In one interpretation, action category R may correspond to a collection of continuation actions that are associated with a particular type of entity, and category S may correspond to a collection of continuation actions that are associated with another type of entity. A type-R entity can specify one of the R-type continuation actions in a continue message to inform a counterpart entity of its particular R-type capabilities. Similarly, a type-S entity can specify one of the S-type continuation actions in a continue message to inform a counterpart entity of its particular S-type capabilities. Again, the hierarchical organization of continuation actions shown in FIG. 5 is merely representative. Other organizations can define other arrangements of continuation actions.

Although not illustrated, similar namespace hierarchies (and associated class hierarchies) can be used to express different types of termination actions and different types of query actions.

In the above description, each of the actions in a hierarchy receives a unique name. However, different actions can have the same name. For example, the actions R1 and S1 shown in FIG. 5 can be assigned the same name. These actions are distinguished from each other because they appear under different respective action categories in the hierarchical namespace. For example, two communication participants can invoke a “Start Charging” action in a start message when communicating with another entity. This same action name may be associated with different operations to be performed. Nevertheless, to clarify the explanation, different actions are assigned different names in the following description.

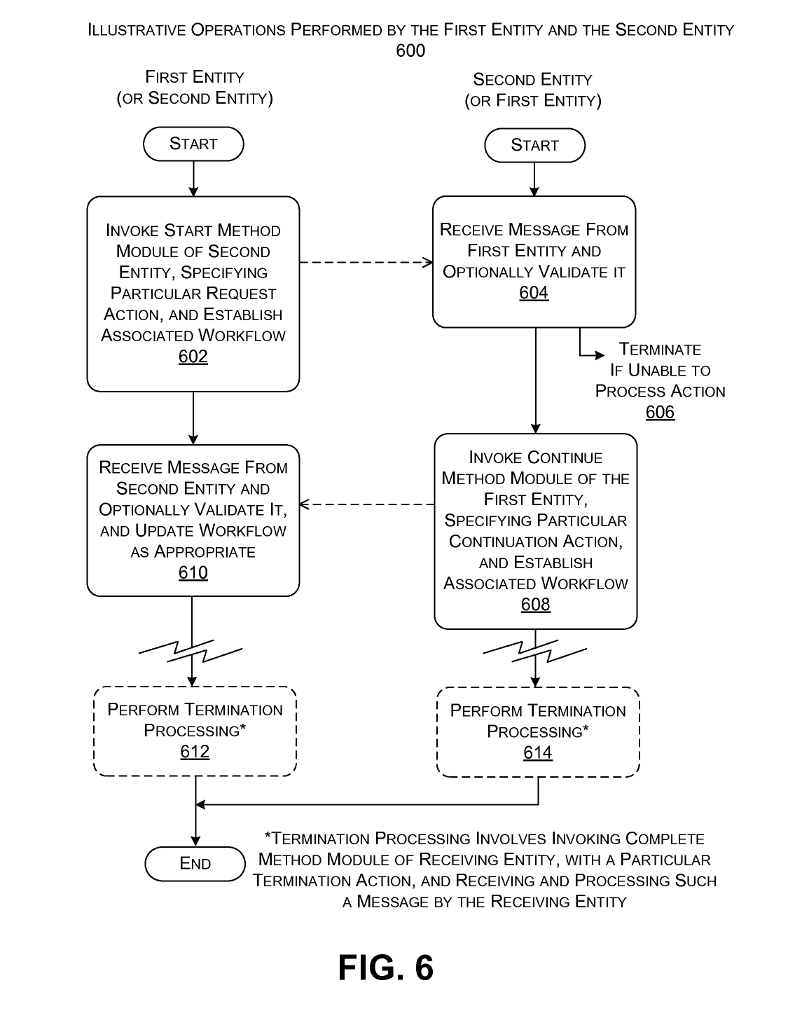

FIG. 6 shows a procedure 600 which expresses the principles set forth above in the form of a flowchart. As in the case of FIG. 3, FIG. 6 indicates that the first entity 102 initiates the conversation; but, in other cases, the second entity 104 can initiate the conversation.

In block 602, the first entity 102 invokes the start method module 204 of the second entity 104. In doing so, the first entity 102 can send a start message which identifies a particular request action. The first entity 102 may also establish a new workflow associated with the conversation that it has initiated. The first entity 102 can also assign one or more identifiers to the newly created workflow.

In block 604, the second entity 104 receives the start message from the first entity 102. The second entity 104 may then optionally validate the start message to determine whether it conforms to an expected form.

In operation 606, the second entity 104 may terminate the conversation if it determines that it cannot carry out the request action specified in the start message. Although not shown, the second entity 104 can communicate its conclusion of block 606 to the first entity 102. In another scenario (not shown), instead of terminating the conversation, the non-acceptance of the request action can invoke a version negotiation, as described above with respect to FIG. 3.

In block 608, presuming that the second entity 104 is able to handle the request action, the second entity 104 can send a continue message to the first entity 102. The continue message specifies a continuation action which conveys a particular version of a communication exchange that the second entity 104 wishes to invoke. The second entity 104 may also establish a new workflow on its own end that is associated with the conversation that the first entity 102 has initiated in block 602. In this manner, both the first entity 102 and the second entity 104 can separately manage workflows associated with the conversation.

In block 610, the first entity 102 receives the continue message and optionally validates it. The first entity 102 then updates the workflow that it has established for the ongoing conversation in an appropriate manner. In some cases, this updating operation may involve associating additional information with the workflow, which it has received from the second entity 104 via the continuation message. In other cases, the first entity 102 may establish a new workflow item which conforms to the particular version of the conversation requested by the second entity 104. In other cases, the first entity 102 may establish a branching workflow which can be executed to yield a result; that result can then be fed back into a parent workflow.

At this juncture, the conversation may involve the sending of any number of subsequent messages of any type, including one or more corresponding continue methods, one or more query messages, and so on.

In blocks 612 and 614, the first entity 102 and the second entity 104 close the conversation. Namely, in this part of the conversation, the first entity 102 or the second entity 104 transmits a complete message to the counterpart entity.

FIG. 7 shows one implementation of a workflow management module 702. As indicated above, the first entity 102 includes a workflow management module 114 for keeping track of ongoing conversations (from its perspective), while the second entity 104 includes a workflow management module 116 for keeping track of ongoing conversations (from its perspective). The type of workflow management module 702 shown in FIG. 7 can be used to implement the workflow management module 114 and the workflow management module 116.

In one implementation, the workflow management module 702 can store descriptive information pertaining to an ongoing conversation. For example, the workflow management module 702 can provide declarative information 704 concerning an ongoing conversation X1, declarative information 706 concerning an ongoing conversation X2, declarative information 708 concerning an ongoing conversation X3, and so on. The declarative information can convey operations to be (and/or which have been) performed by a conversation, the status of various operations, and so on.

The workflow management module 702 is configured to update the declarative information for a conversation when operations have been completed and/or when the course of a conversation changes. For example, a caller entity may receive a continue message from a callee entity which specifies that an ongoing conversation is to follow a course A instead of a course B. The workflow management module 702 can make appropriate changes to the declarative information associated with the ongoing conversation, e.g., by revising an indication of operations that are to be carried out by the conversation.

An entity may carry out the actions specified in declarative form by accessing code modules in a library 710 and then instantiating those code modules. For example, assume that a declarative task description specifies that action L is to be performed by the entity; at an appropriate juncture in the conversation, the entity can access a code module in the library 710 which carries out the action L, and then instantiate it. In one case, the code modules in library 710 can correspond to respective classes; the library 710 can structure those classes in one or more hierarchies defined by the action structures described above.

B. Representative Implementation of Computer System

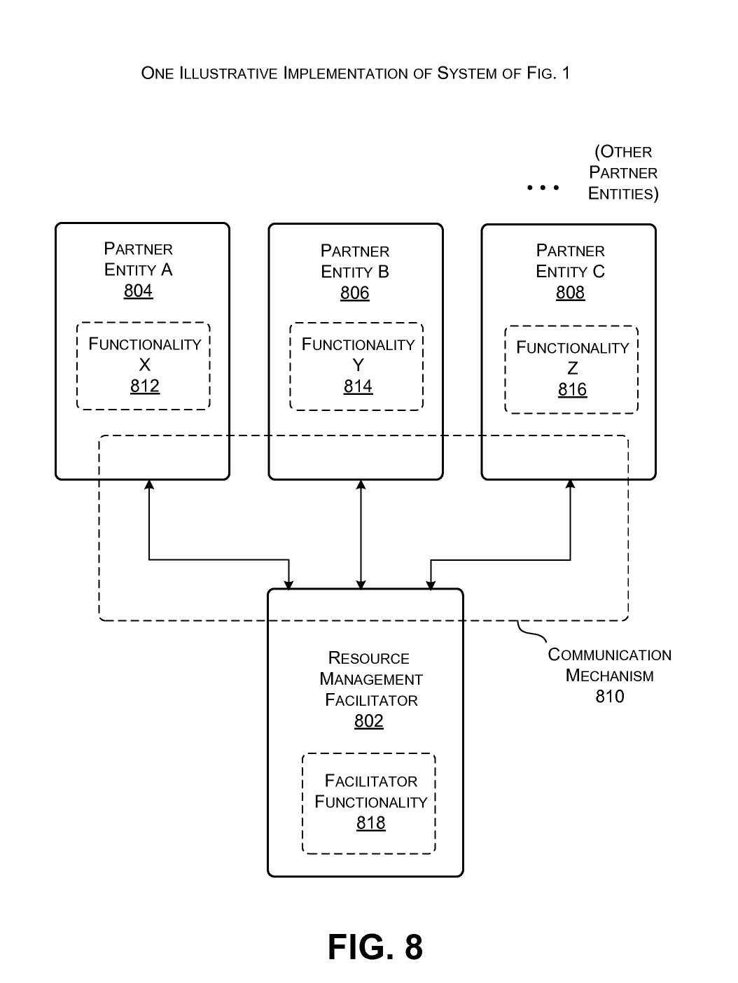

The system 100 of FIG. 1 can be applied to different environments. FIG. 8 shows one illustrative implementation 800 of the system 100 in an environment that involves the management of a resource. The term “resource” encompasses any tangible or intangible goods or services that can be provided to a user and tracked on a specified basis (e.g., a per-unit basis). Without limitation, a resource may correspond to an energy-related resource, such as electricity, gas, heating oil, water, and so on. The term “resource-related information” encompasses any information associated with a resource. In other cases, the system 100 of FIG. 1 can be applied to other types of environments associated with other respective conversations, such as financial environments, heath services environments, business-to-business communication environments of any type, and so on.

In the environment of FIG. 1, a resource management facilitator 802 (“facilitator”) communicates with one or more partner entities (804, 806, 808) via a communication mechanism 810. Each of these agents (802, 804, 806, 808) may be implemented by one or more processing devices, one or more data stores, and/or other processing equipment. The agents (802, 804, 806, 808) may communicate with each other using any type of network, such as a wide area network (e.g., the Internet), a local area network, point-to-point connections, or any combination thereof.

In one environment, the partner entities (804, 806, 808) correspond to different respective utility entities. For example, the utility entities may correspond to different commercial providers of resources, such as one or more regional providers of electricity, one or more regional providers of natural gas, and so on. Alternatively, or in addition, the utility entities may correspond to more localized providers of resources, such as homeowners who produce excess electricity for use by other users. Alternatively, or in addition, the utility entities may correspond to aggregator entities which collect resource-related information from other utility-related sources, etc.

In a utility-related environment, the facilitator 802 may collect resource-related information from the partner entities (804, 806, 808). The facilitator 802 can then allow users to access their own respective resource-related information. For example, the facilitator 802 can allow a user to register to interact with the services that it provides. After registration, the user may access usage and invoice information which describes that user's consumption of gas and/or electricity within his or her household or other relevant building unit.

In another environment, the different partner entities (804, 806, 808) may correspond to controllable devices. Each controllable device manages the consumption of energy in a particular environment. For example, a controllable device may manage the consumption of energy within a building unit. Alternatively, or in addition, a controllable device may manage the charging of an electrical vehicle, e.g., by governing the timing at which the electric vehicle is charged. In these contexts, the facilitator 802 can send appropriate instructions to a controllable device which governs the decisions made by the controllable device. In another scenario, the facilitator can send appropriate instructions to a partner entity; the partner entity can then forward the instructions to a controllable device.

The above scenarios are illustrative rather than exhaustive; that is, the type of system shown in FIG. 8 can be applied to yet other energy management environments. In any case, the facilitator 802 can take appropriate precautions to safeguard the privacy of information associated with users. Moreover, the facilitator 802 can allow the users to expressly opt in or opt out of its various services. Moreover, the facilitator 802 can allow users to control their data, including the creation, deletion, and dissemination of the data.

In any environment, the communication mechanism 810 can implement the exchange of messages between the partner entities (804, 806, 808) and the facilitator 802 according to principles described above in Section A. As such, the facilitator 802 and each of the partner entities (804, 806, 808) implement the common set of method modules shown in FIG. 2. The common method modules include a start method module, a continue method module, a complete method module, and a query method module. To invoke a method module, a sending entity sends a message that identifies a particular action to an appropriate endpoint. The specified action is selected from a hierarchical namespace of actions in the manner described above.

FIG. 8 indicates that the partner entities (804, 806, 808) have different respective partner functionalities (812, 814, 816) and different respective capabilities defined thereby. The facilitator 802 itself has facilitator functionality 818 and an associated capability defined thereby. In view of the features described in Section A, the facilitator 802 can interact with the partner entities (804, 806, 808) even though the facilitator functionality 818 may be different from the partner functionalities (812, 814, 816). Further, the facilitator 802 need not have advance knowledge of the capabilities of the partner entities (804, 806, 808). Nor need any partner entity have knowledge of the capabilities of other partner entities. These characteristics result in an overall framework that is flexible and scalable (in the sense that it can readily accommodate the introduction of new message exchange versions and/or previous message exchange versions).

To clearly demarcate concepts, FIG. 8 shows that the partner functionalities (812, 814, 816) are distinct from the first communication mechanism 810; further, FIG. 8 shows that the facilitator functionality 818 is distinct from the communication mechanism 810. However, at least part of the functionalities (812, 814, 816, 818) can be implemented by the communication mechanism 810.

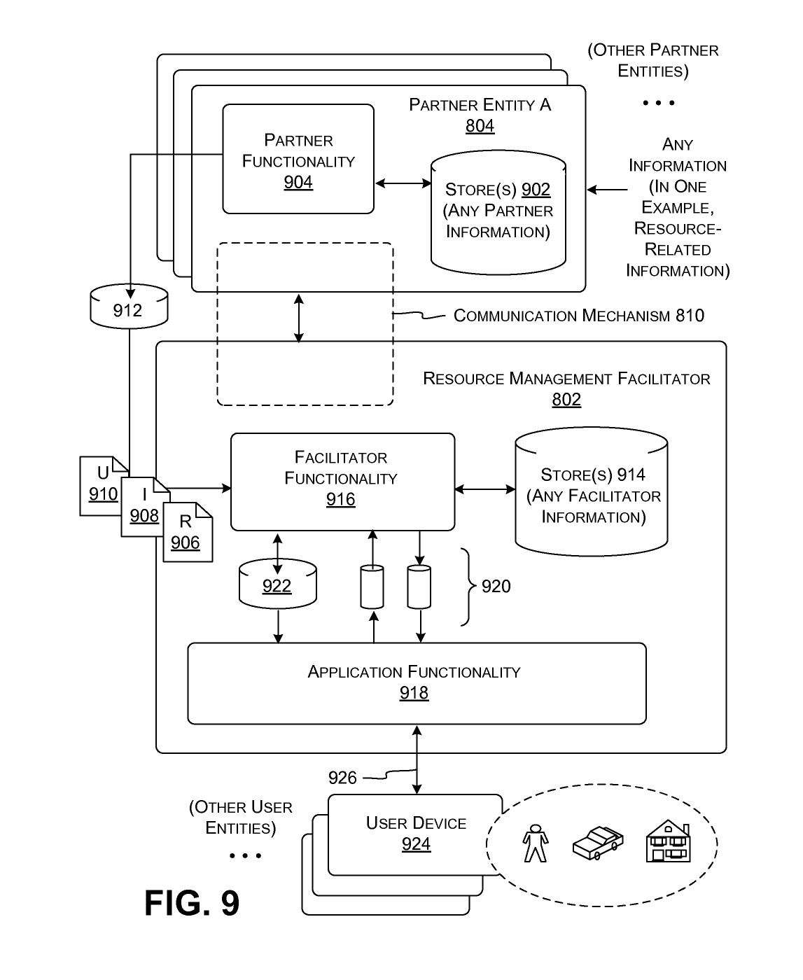

FIG. 9 shows additional details of one implementation of the environment shown in FIG. 8. Namely, FIG. 9 shows illustrative components of the facilitator 802 and illustrative components of a representative partner entity 804. Other partner entities, although not shown, can be implemented in a manner similar to that shown for partner entity 804. More generally, in this example, the partner entities correspond to respective utility entities which provide resource-related information to the facilitator 802, for eventual dissemination to authorized users.

Explaining FIG. 9 from top to bottom, the partner entity 804 receives resource-related information from various sources. For example, the partner entity 804 may receive resource-information which reflects the consumption of resources (e.g., gas, electricity, etc.) by a plurality of users. The partner entity 804 can collect the resource-related information from service points associated with the users. For example the service points may correspond to metering mechanisms associated with respective building units. The partner entity 804 can collect this information in an automated manner (e.g., via one or more networks), in a manual manner (e.g., by manually visiting and interacting with the service points), or by a combination of automatic and manual methods. The partner entity 804 can store the collected resource-related information in one or more data stores 902.

Partner functionality 904 can transfer the resource-related information to the facilitator 802. The facilitator 802, in turn, can make this data accessible to authorized users. More specifically, the facilitator 802 asks each source of resource-related information to package the resource-related information into a predetermined format. In one implementation, for instance, the facilitator 802 asks each utility entity to express the resource-related information in three files. A resource usage file 906 expresses the consumption of resources by one or more users. An invoice file 908 expresses invoice information associated with the consumption of resources by one or more users. And a rate file 910 expresses rate information which has a bearing on the cost of the resources. Each file expresses the resource-related information using a data structure, as governed by a schema. The copending '248 application, identified above, describes illustrative formats of the three resource-related files (906, 908, 910), although the resource-related information can be expressed in other formats as well. Further, the partner entity 804 and the facilitator 802 can alternatively, or in addition, exchange other kinds of information having any scope of applicability, such as any type of pricing information (such as tariff information), any type of scheduling information, etc.

In one implementation, the partner entity 804 forwards the resource-related information to the facilitator 802 by uploading the resource-related information to a network-accessible store 912. The partner entity 804 can communicate information to facilitator 802 which identifies the access address of the network-accessible store 912. The facilitator 802 can then retrieve the resource-related information from the network-accessible store 912.

The facilitator 802 itself can include one or more data stores 914 for storing the resource-related information that it receives, as well as other information that it uses to provide its services. The facilitator 802 can include facilitator functionality 916 which manages the receipt and dissemination of the resource-related information provided in the network-accessible store 912.

Application functionality 918 provides an interface which allows users to interact with the facilitator 802. Namely, the application functionality 918 can provide various interfaces which allow a user to register to receive resource-related information from the facilitator 802, and also to revoke (or disable) a prior registration. The application functionality 918 also provides various interfaces which allow a user to access resource-related information that has been gathered by the facilitator 802. In addition, the application functionality 918 may provide various interfaces which allow a user to perform any type of energy management analysis on the basis of resource-related information provided by the facilitator 802. The application functionality 918 can provide yet other types of services to the user.

The application functionality 918 may interact with the facilitator functionality 916 via various interaction mechanisms. For example, the facilitator 802 can provide one or more queues 920 for retaining information that pertains to ongoing conversations. This enables the application functionality 918 to handle multiple tasks without being held up by pending tasks. The interaction mechanisms may also include a store 922 for storing data, such as resource-related data that can be accessed by authorized users and the application functionality 918 alike.

Users may interact with the application functionality 918 via one or more devices, such as representative user device 924. The user device 924 may correspond to any type of computing device, such as a personal computing device, a desktop computing device, a laptop computing device, a mobile telephone device, a personal digital assistant device, a game console device, a set-top box device, an application-specific energy management device, and so on. The user devices may interact with the application functionality 918 via any type of connection 926, such as a wide area network (e.g., Internet) connection.

A user may interact with the facilitator 802 to achieve various goals. In one case, the user may interact with facilitator 802 to examine his or her consumption of energy resources. Alternatively, or in addition, the user may interact with the facilitator 802 to perform analysis regarding his or her energy consumption; the user can apply insight gained thereby to make more efficient use of energy resources. Alternatively, or in addition, the user (or a controllable device associated with the user) may interact with the facilitator 802 to determine the manner in which an electrical vehicle is to be charged, and so on.

The communication mechanism 810 shown in FIG. 9 can handle different types of conversations to achieve different aims. In one case, the communication mechanism 810 can conduct an exchange of messages to register a user. In another case, the communication mechanism 810 can conduct an exchange of messages to revoke the prior registration of a user (referred to as de-registration). In another case, the communication mechanism 810 can conduct an exchange of messages to gather resource-related information from the partner entity 804.

FIGS. 10 and 11 show two versions of a message exchange for registering a user. The communication mechanism 810 applies the first message exchange (of FIG. 10) when the partner entity 804 has a first capability, and it applies the second message exchange (of FIG. 11) when the partner entity 804 has a second capability. More specifically, in the first case, the partner entity 804 is not set up to invoke the transfer of resource-related information as part of the registration process. In the second case, the partner entity 804 does have this data transfer capability.

Starting with FIG. 10, in operation 1002, the user interacts with the application functionality 918 to initiate the registration process. This may involve receiving answers to questions from the user; these answers will later be used to authorize the user to access resource-related information provided by the partner entity 804. The application functionality 918 and facilitator functionality 916 then trigger the communication mechanism 810 to commence a message exchange between the facilitator 802 and the partner entity 804 for the purpose of registering a user to receive resource-related information from the partner entity 804.

In operation 1004, the facilitator 802 invokes the start method module of the partner entity 804. Namely, the facilitator 802 transmits a start message to the partner entity 804. That start message specifies a particular request action, namely a Register_Customer request action. More specifically, the Register_Customer request action is one of a set of possible request actions that can be invoked, all derived from a request base class. The partner entity 804 may send an acknowledgement message which acknowledges receipt of the start message.

In operation 1006, the partner entity 804 optionally performs validation on the start message to ensure that it conforms to a proper form that is expected.

In operation 1008, the partner entity 804 can optionally invoke the continue method module of the facilitator 802, e.g., by sending a continue message to the facilitator 802. The continue message can specify a particular continuation action, namely, Reg_Without_Data. This message thereby informs the facilitator 802 that the partner entity 804 seeks to invoke a particular version of the customer registration message exchange which does not involve the transfer of resource-related information. The facilitator 802 may send an acknowledgement message which acknowledges receipt of the continue message.

In operation 1010, the facilitator 802 can optionally perform validation of the continue message to ensure that it conforms to a proper form that is expected.

In operation 1012, the facilitator 802 can send a complete message to the partner entity 804 to notify the partner entity 804 of the termination of the communication exchange. The complete message can specify a Register_Complete action. The partner entity 804 can then send an acknowledgement message which acknowledges receipt of the complete message. In another case, the partner entity 804 can send the complete message to the facilitator 802.

In operation 1014, the partner entity 804 can optionally perform validation of the complete message to ensure that it conforms to a proper form that is expected.

The above-described protocol is merely representative. For example, in another implementation, the partner entity 804 can immediately send a complete message after it receives the start message (e.g., without first sending the continue message). This is because the partner entity 804 can forward all of the appropriate customer registration information to the facilitator 802 in the complete message itself. Further, this message itself informs the facilitator 802 of the fact that the partner entity 804 wishes to handle registration without the transfer of resource-related information.

Now advancing to FIG. 11, this figure shows a version of the customer registration message exchange that involves the transfer of resource-related information.

In operation 1102, the user interacts with the application functionality 918 to initiate the registration process in the same manner described above (with respect to FIG. 10). In operation 1104, the facilitator 802 sends a start message to the partner entity 804. Like described above, the start message specifies a Register_Customer request action. The partner entity 804 may send an acknowledgement message which acknowledges receipt of the start message.

In operation 1106, the partner entity 804 optionally performs validation on the start message to ensure that it conforms to a proper form that is expected.

In operation 1108, the partner entity 804 can optionally invoke the continue method module of the facilitator 802, e.g., by sending a continue message to the facilitator 802. In this case, the continue message can specify Reg_With_Data continuation action. This message thereby informs the facilitator 802 that the partner entity 804 seeks to invoke a particular version of the customer registration message exchange which involves the transfer of resource-related information. The facilitator 802 may send an acknowledgement message which acknowledges receipt of the continue message.

In operation 1110, the facilitator 802 can optionally perform validation of the continue message to ensure that it conforms to a proper form that is expected.

In operation 1112, the facilitator 802 and the partner entity 804 engage in a message exchange whereby the facilitator 802 obtains resource-related information from the partner entity 804. In this exchange, the facilitator 802 can retrieve the resource-related information from a storage location indicated by the continue message.

In operation 1114, the facilitator 802 can send a complete message to the partner entity 804 to notify the partner entity 804 of the termination of the communication exchange. The partner entity 804 can then send an acknowledgement message which acknowledges receipt of the complete message.

In operation 1116, the partner entity 804 can optionally perform validation of the complete message to ensure that it conforms to a proper form that is expected.

The various messages identified in FIGS. 10 and 11 can include respective data structures which provide different items of information. In one case, the data structures can express information in the XML format. For example, in FIG. 10, the Register_Customer action sent to the partner entity's 804 start method module can include a partner identifier and a conversation identifier. The Register_Customer action can also identify answers to questions that the user has provided (for use in authorizing the user).

In FIG. 11, the Reg_With_Data action sent to the facilitator's 802 continue method module can include the partner identifier and the conversation identifier described above, which can be inherited from the continuation base class. The Reg_With_Data action can also include an identifier associated with a user for whom the registration is being performed. The Reg_With_Data action can also identify a URL at which a file containing resource-related information is stored, the namespace of an XSD used to validate the file, security information, and so on.

The partner entity 804 can also independently notify the facilitator 802 of the existence of resource-related information to be transferred to the facilitator 802. The partner entity 804 performs this task by sending a start message to the start method module of the facilitator 802, specifying a Files_Available action. The Files_Available action identifies the type of file information described above.

Consider next another scenario in which the facilitator 802 interacts with a controllable device that is used to charge an electric vehicle. In one conversation option, the facilitator 802 can initiate the conversation by sending a start message to the controllable device, specifying a Charge_Immediately request action. The controllable device can respond by immediately commencing charging of the electric vehicle. Alternatively, the facilitator 802 can initiate the conversation by sending a start message to the controllable device, this time specifying a Charge_As_Per_Schedule request action. The controllable device can respond by commencing charging in accordance with a schedule that is a part of the start message.

Still other scenarios are possible whereby either the facilitator 802 or the partner entity 804, or both, attempt to dictate the course of the ongoing conversation at various junctures of the conversation.

C. Representative Processing Functionality

FIG. 12 sets forth illustrative electrical data processing functionality 1200 that can be used to implement any aspect of the functions described above. With reference to FIG. 1, for instance, the type of processing functionality 1200 shown in FIG. 12 can be used to implement any aspect of the computer system 100. With reference to FIG. 8, the type of processing functionality 1200 shown in FIG. 12 can be used to implement any aspect of any partner entity and/or the facilitator 802. In one case, the processing functionality 1200 may correspond to any type of computing device (or plural such devices), each of which includes one or more processing devices.

The processing functionality 1200 can include volatile and non-volatile memory, such as RAM 1202 and ROM 1204, as well as one or more processing devices 1206. The processing functionality 1200 also optionally includes various media devices 1208, such as a hard disk module, an optical disk module, and so forth. The processing functionality 1200 can perform various operations identified above when the processing device(s) 1206 executes instructions that are maintained by memory (e.g., RAM 1202, ROM 1204, and/or elsewhere). More generally, instructions and other information can be stored on any computer readable medium 1210, including, but not limited to, static memory storage devices, magnetic storage devices, optical storage devices, and so on. The term computer readable medium also encompasses plural storage devices.

The processing functionality 1200 also includes an input/output module 1212 for receiving various inputs from a user (via input modules 1214), and for providing various outputs to the user (via output modules). One particular output mechanism may include a presentation module 1216 and an associated graphical user interface (GUI) 1218. The processing functionality 1200 can also include one or more network interfaces 1220 for exchanging data with other devices via one or more communication conduits 1222. One or more communication buses 1224 communicatively couple the above-described components together.

In closing, the description may have described various concepts in the context of illustrative challenges or problems. This manner of explication does not constitute an admission that others have appreciated and/or articulated the challenges or problems in the manner specified herein.

Further, the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for exchanging messages between a first entity and a second entity, comprising:
a communication mechanism implemented by the first entity and the second entity, the communication mechanism comprising a first communication module implemented by the first entity and a second communication module implemented by the second entity,
the first communication module providing a first set of method modules for performing respective communication tasks,
the second communication module providing a second set of method modules for performing respective communication tasks, the method modules in the second set serving same communication roles as counterpart method modules in the first set,
each method module being configured to send and receive an invoking message that specifies a particular action to be taken, the particular action being selected from a collection of possible actions, and
the first entity and the second entity being referred to as a sending entity and receiving entity, respectively, when the first entity sends the invoking message to the second entity, and the first entity and the second entity being referred to as the receiving entity and the sending entity, respectively, when the second entity sends the invoking message to the first entity.

2. The computer system of claim 1, wherein the first entity and the second entity include different respective functionalities associated with different respective versions of possible communication exchanges, and wherein the sending entity is configured to send the invoking message to the receiving entity to inform the receiving entity of a particular version of a communication exchange that it seeks to invoke.

3. The computer system of claim 1, wherein the first set of method modules and the second set of method modules each implements a start method module, wherein the sending entity is configured to send a start message to invoke a start method module of the receiving entity, to thereby request the receiving entity to initiate a particular request action specified in the start message, the sending entity being referred to as a caller entity and the receiving entity being referred to as a callee entity.

4. The computer system of claim 3, wherein the first set of method modules and the second set of method modules each implements a continue method module, wherein the callee entity is configured to send a continue message to the caller entity, to thereby inform the caller entity of a particular continuation action that the callee entity seeks to invoke.

5. The computer system of claim 1, wherein the first set of method modules and the second sets of method modules each implements a complete method module, wherein the sending entity is configured to send the receiving entity a complete message to thereby inform the receiving entity of a particular termination action that the sending entity seeks to invoke.

6. The computer system of claim 1, wherein the first set of method modules and the second set of method modules each implements a query method module, wherein the sending entity is configured to send the receiving entity a query message to thereby determine an aspect of an ongoing conversation.

7. The computer system of claim 1, wherein the communication mechanism is configured to perform a version negotiation whereby the sending entity sends at least a subsequent invoking message upon an indication that the receiving entity has not accepted a previously-sent invoking message, the subsequent invoking message specifying a different action than is specified in the previously-sent invoking message.

8. The computer system of claim 1, wherein the collection of possible actions is a hierarchical collection of possible actions associated with a base action class.

9. The computer system of claim 1, wherein a message exchange conducted between the first entity and the second entity pertains to management of a resource.

10. The computer system of claim 9, wherein the first entity comprises a resource management facilitator and the second entity is associated with a partner entity, wherein the resource management facilitator is configured to provide an energy management service to at least one user.

11. The computer system of claim 10, wherein the partner entity is a utility entity, and wherein the resource management facilitator is configured to collect resource-related information from the utility entity for dissemination to said at least one user.

12. A method using a computer system for exchanging messages, comprising:
receiving, by a callee entity, a start message from a caller entity, the start message invoking a start method module provided the callee entity, and the start message specifying a particular request action to be performed by the callee entity; and
sending a continue message, by the callee entity, to the caller entity, the continue message specifying a particular continuation action,
the particular request action selected from a collection of possible request actions, and
the particular continuation action selected from a collection of possible continuation actions.

13. The method of claim 12, wherein the first entity and the second entity include different respective functionalities associated with different respective versions of possible communication exchanges.

14. The method of claim 12, wherein the particular request action informs the callee entity of a particular version of a communication exchange that the caller entity seeks to invoke.

15. The method of claim 12, wherein the particular continuation action informs the caller entity of a particular version of a communication exchange that the callee entity seeks to invoke.

16. The method of claim 12, further comprising performing a version negotiation, comprising:
conveying, by the callee entity to the caller entity, an indication that the callee entity has not accepted the start message that specifies the particular request action; and
in response to said conveying, receiving, by the callee entity from the caller entity, another start message that specifies another particular request action.

17. The method of claim 12, wherein a message exchange conducted between the first entity and the second entity pertains to management of a resource.

18. The method of claim 17, wherein the first entity comprises a resource management facilitator and the second entity is associated with a utility entity, and wherein the resource management facilitator is operative to collect resource information from the utility entity for dissemination to at least one user.

19. The method of claim 12, wherein the first entity comprises a resource management facilitator and the second entity is associated with a controllable device for controlling consumption of an energy resource in at least one environment.

20. A computer readable storage medium for storing computer readable instructions, the computer readable instructions providing a communication module when executed by one or more processing devices, the communication module being implemented by a first entity which communicates with a second entity, the computer readable instructions comprising:
a start method module for sending and receiving start messages, each start message that is received from the second entity requesting the first entity to initiate a particular request action specified in the start message;
a continue method module for sending and receiving continue messages, each continue message that is received from the second entity informing the first entity of a particular version of a communication exchange that is to be invoked in order to communicate with the second entity after receiving a start message from the second entity; and
a complete method module for sending and receiving complete messages, each complete message received from the second entity requesting the first entity to perform a particular termination action specified in the complete message,
at least one of the start message, the continue message, and the complete message specifying an action that is selected from a hierarchical collection of possible actions.
